(19) United States
(12) Patent Application Publication
(10) Pub. No.: US 2023/0014029 A1
(43) Pub. Date: Jan. 19, 2023

(54) LOCAL INDEXING FOR METADATA REPOSITORY OBJECTS

(71) Applicant: SAP SE, Walldorf (DE)

(72) Inventors: Markus Viol, Walldorf (DE); Eugen Resch, Rauenberg (DE); Rick Weigel, Rheinstetten (DE); Rashmi Nagendra, Malsch (DE); Aditya Bhatia, Schwetzingen (DE)

(21) Appl. No.: 17/368,267

(22) Filed: Jul. 6, 2021

(51) Int. Cl. G06F 16/16; G06F 16/17; G06F 16/182; G06F 40/47

(52) U.S. Cl. CPC G06F 16/164; G06F 16/1734; G06F 16/1827; G06F 40/47

(57) ABSTRACT

A method, a system, and a computer program product for retrieving metadata files using a local metadata index. A request to access one or more metadata files associated with at least one computing component is received. At least one primary key and at least secondary key identifying the computing component are determined. An identifier of a storage location storing the metadata files is associated with the primary key and the secondary key. A metadata index for the metadata files is generated. The metadata index includes the primary key, the secondary key, and the associated identifier of the storage location. The metadata index is stored in a memory location associated with the computing component. The stored metadata index is accessed and the metadata files are retrieved using the stored metadata index.

### TECHNICAL FIELD

This disclosure relates generally to data processing and, in particular, to local indexing for metadata repository objects.

### BACKGROUND

In today's world, many companies rely on software applications to conduct their business. Software applications deal with various aspects of companies' businesses, which can include finances, product development, human resources, customer service, management, and many other aspects. Software applications typically operate from servers and can be stored in memory. Many software applications may be associated with various metadata that may include specific configurations, preferences, upgrades, etc. Quick access to such metadata is important for efficient operation of computing systems, software applications, etc.

### SUMMARY

In some implementations, the current subject matter relates to a computer implemented method for retrieving metadata files using a local metadata index. The method may include receiving a request to access one or more metadata files associated with at least one computing component, determining at least one primary key and at least secondary key identifying the computing component, associating an identifier of a storage location storing the metadata files with the primary key and the secondary key, and generating metadata index for the metadata files. The metadata index may include the primary key, the secondary key, and the associated identifier of the storage location. The metadata index may be stored in a memory location associated with the computing component. The method may also include accessing the stored metadata index and retrieving, using the stored metadata index, the metadata files.

In some implementations, the current subject matter may include one or more of the following optional features. For example, the computing component may include at least one of the following: a file system, a software application, one or more modifications to the file system, one more modification to the software application, and any combination thereof. The metadata files may be stored in at least one of the following: a local file system image, a database of a metadata object repository, and any combination thereof.

In some implementations, the identifier of the storage location may include a file path associated with the metadata files. The primary key may include a name associated with the computing component. The secondary key may include a type of the computing component. Alternatively, or in addition to, the secondary key may include one or more attributes associated with the computing component. Further, the secondary key may include an identification of a language associated with the metadata files. The metadata files may include one or more metadata files translated into at least one or more languages.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary system for generating a local metadata index, according to some implementations of the current subject matter;

FIG. 2 illustrates an exemplary local file system image, according to some implementations of the current subject matter;

FIG. 3 illustrates an exemplary process for extraction of requested metadata, according to some implementations of the current subject matter;

FIG. 4 illustrates an exemplary local index, according to some implementations of the current subject matter;

FIG. 5 is a diagram illustrating an exemplary system including a data storage application, according to some implementations of the current subject matter;

FIG. 6 is a diagram illustrating details of the system of FIG. 5;

FIG. 7 illustrates an exemplary system, according to some implementations of the current subject matter; and

FIG. 8 illustrates an exemplary method, according to some implementations of the current subject matter.

### DETAILED DESCRIPTION

To address the deficiencies of currently available solutions, one or more implementations of the current subject matter provide for an ability to provide for local indexing for metadata repository objects.

In some implementations, the current subject matter may be configured to generate a local metadata index for a particular system, software application, etc. operating in a computing environment (e.g., cluster computing environment, cloud computing environment, etc.) and use the index to retrieve metadata files. To generate the index, the current subject matter may be configured to determine at least one primary key and at least secondary key identifying the computing component. These may include a name (e.g., namespace), a type, and/or any other keys. The keys may be associated with file path in a storage location storing the metadata files that may have been requested. The current subject matter may then be configured to generate a metadata index for the metadata files, where the metadata index may include the keys and the associated file path to the storage location. The metadata index may be stored in a memory location associated with the computing component. It may be used to retrieve metadata files.

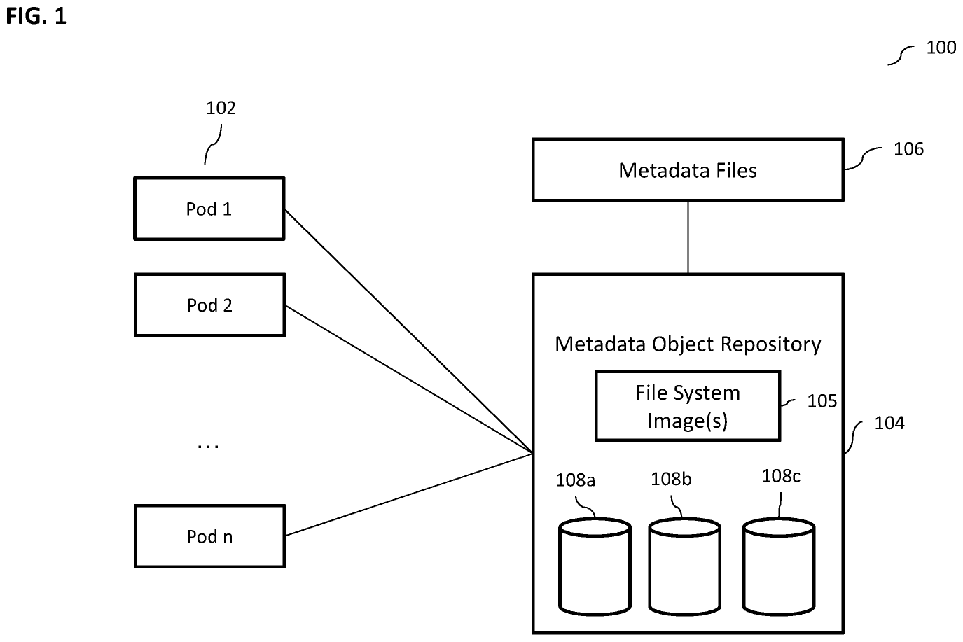

FIG. 1 illustrates an exemplary system 100 for generating a local metadata index, according to some implementations of the current subject matter. The system 100 may include one or more applications and/or pods and/or entities 102 (e.g., pod 1, pod 2, etc.), and a metadata object repository 104 that may be used for storage of one or more metadata files 106. The entities 102 may be deployable grouping of containerized computing components. An entity 102 may include of one or more containers (not shown in FIG. 1) that may be guaranteed to be co-located on the same node. The entities 102 may be created and/or managed in a computing environment (e.g., Kubernetes). An entity may have a shared storage and/or network resources, along with an indication of how to run the containers. The entity's contents may be co-located, co-scheduled, and/or run in a shared context.

Components of the system 100 may be communicatively coupled using one or more communications networks. The communications networks can include at least one of the following: a wired network, a wireless network, a metropolitan area network (“MAN”), a local area network (“LAN”), a wide area network (“WAN”), a virtual local area network (“VLAN”), an internet, an extranet, an intranet, and/or any other type of network and/or any combination thereof.

The components of the system 100 may include any combination of hardware and/or software. In some implementations, the components may be disposed on one or more computing devices, such as, server(s), database(s), personal computer(s), laptop(s), cellular telephone(s), smartphone(s), tablet computer(s), and/or any other computing devices and/or any combination thereof. In some implementations, the components may be disposed on a single computing device and/or can be part of a single communications network. Alternatively, the components may be separately located from one another.

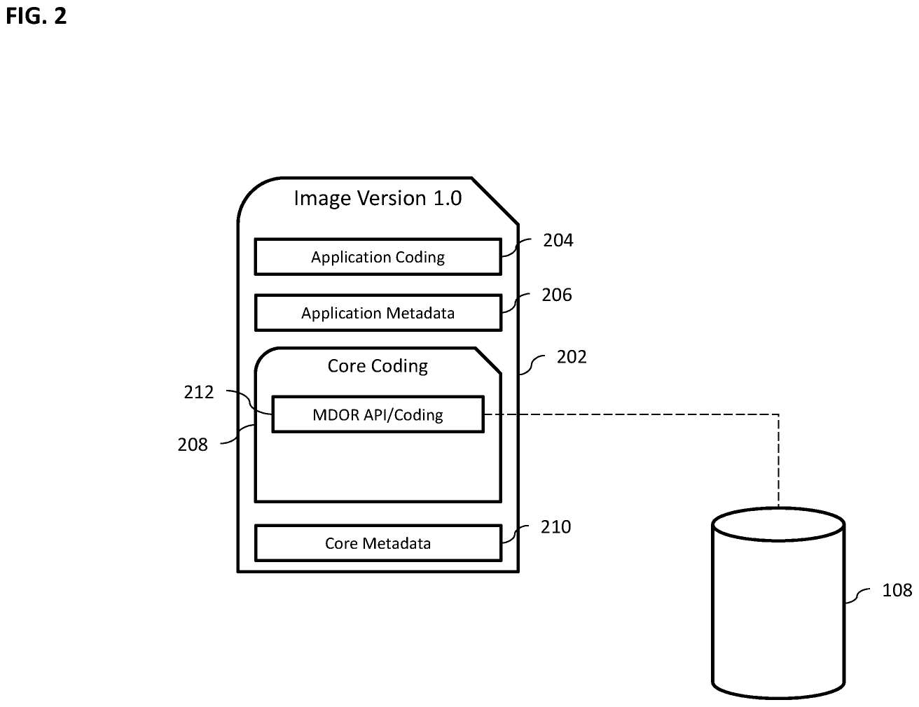

The metadata files 106 may be imported into the metadata object repository (MDOR) 104 (such as, during system provisioning) and may represent a file system image (e.g., as shown in FIG. 2), which may include a core software application image (e.g., software application code and any associated files), software version information, etc. The MDOR 104 may be configured to provide all entities, for all software applications, in all software versions, including specific entities with a dedicated computing cluster (e.g., Kubernetes cluster). It may also include various modifications, preferences, changes, add-ons, personalization, etc. that may be created/generated by a user (e.g., tenant) of the software application. The repository 104 may be configured to include one or more databases 108 (a, b, c) that may be configured to store file various metadata files that may represent such changes and that may have been imported into the repository 104.

In some implementations, during runtime, an entity 102 may access the metadata object repository 104 to obtain access to/read one or more file system images and/or metadata files. For example, a query may be generated by the entity 102 and transmitted to the metadata object repository 104, which may determine whether the repository 104 may contain requested file system image, metadata files, accompanying files, etc. and retrieve appropriate information. One or more entities 102 may include individual user devices, computing devices, software applications, clusters, objects, functions, and/or any other types of users, applications, clusters, and/or any combination thereof.

In some implementations, the metadata object repository 104 may include a file system image(s) storage component 105. The component 105 may be configured to store file system images (e.g., image 202 shown in FIG. 2). The repository 104 may also make a determination as to whether or not specific requested file system images are stored in the repository 104 (e.g., by the component 105) and/or which database 108 may store metadata associated with the file system image(s). Once the repository 104 determines that a particular file system image is stored in the component 105 and/or any additional metadata is stored in a specific database 108, it may retrieve the file system image from the component 105 and metadata from that database 108 and provide it to the requesting entity 102.

The databases 108 may be configured to store metadata in any desired format, e.g., table format, column-row format, key-value format, etc. (e.g., each key may be indicative of various attributes and each corresponding value may be indicative of attribute's value). As can be understood, the data may be stored in any other desired format.

FIG. 2 illustrates an exemplary file system, software application, etc. image 202 (hereinafter, referred to as “file system image” or “application image” or “image”), according to some implementations of the current subject matter. The image 202 may be stored the component 105 and/or in one or more databases 108 of the repository 104. The image 202 may include various code, an indication of a version, application programming interface(s) (API), as well as any other information associated with the system, software application, etc. For example (as shown in FIG. 2), the image 202 may represent “Image Version 1.0” of a specific system, software application, etc.

In particular, as shown in FIG. 2, the image 202 may include application code component 204, application metadata component 206, core coding component 208, and core metadata component 210. The application code component 204 and application metadata component 206 may contain coding and/or metadata, respectively associated with various software applications that may form part of the file system image 202. The core coding component 208 may be configured to store core system coding components (e.g., computing environment, files, executables, and/or any other components) that may be required for the system to operate. The component 208 may include various system, application configuration, management, integration, etc. information. The core coding component 208 may also contain one or more application programming interfaces (APIs) that may be used for connection to various other components and for ensuring interoperability of the system and its components as well as interactions with users. For example, the component 208 may be configured to store MDOR API/coding component 212. The component 212 may provide an API for interaction with the MDOR 104 and its components. For example, the MDOR API/coding component 212 may be configured to provide an interface with the database 108 of the system 100 (shown in FIG. 1). In particular, the component 212 may be configured to process any access requests for metadata that may be received by the repository 204 and obtain/provide requested metadata (for the correct software application and/or its specific requested version) from the database 108 (as shown in FIGS. 1 and 2).

In some cases, entities might not be able to read metadata directly from the file system image, but instead must read the metadata from the metadata object repository. This may be due to various reasons, such as, queries performed for entities in the same namespace, of the same type, etc. Also, at runtime, entities may be different from entities at the design time (e.g., corresponding to the image of the system). For example, at runtime, a user interface definition metadata object may be requested along with all its translated text and personalization/adaptation objects and applied to the design time (e.g., file system image) user interface file, whereby runtime requested result may correspond to the merged result of all of this data, which creates a runtime vs. design-time difference. Further, the entities may be affected by user specific changes that might not be part of the image itself. Moreover, software applications may require a substantial amount of metadata that may include, for instance, user interface(s) definition(s) file(s), object(s) definition(s) file(s), data types file(s) that may be used by the object(s), translated text(s) for the user interface(s), user-specific personalization data, key-user adaptation(s) data related to the software application, and other metadata. The sizes of the files containing this metadata may be significant, which may burden the traffic bandwidth between the repository and the entity, application, etc. requesting metadata. Further, while obtaining the requested metadata, it may be important that the repository enables one or more of the following functionalities, for instance, a zero downtime upgrade, a configurable subscription and un-subscription for add-ons, tenant isolation, key-user adaptation, end-user personalization, a harmonized access to all of the metadata entities, a SAAS approach including all appropriate extensions (as add-ons and key-user adaptations may be metadata based).

In some implementations, since the software application version related metadata may already be part of the file system image (e.g., image 202 as shown in FIG. 2) and may be imported to the MDOR database 108 during computing system provisioning process, the current subject matter may be configured to read the metadata directly from the file system component 105 as opposed to from the database 108. The metadata associated with the file system image may already be in the correct software version available because it might only be used for this file system image. Any modifications, changes, such as tenant specific metadata, etc., which might not be part of the file system image itself, must be retrieved (e.g., fetched) from the database 108. As such, the overall metadata may be a combination of the metadata of the file system image (e.g., image 202), as related to the file system, and metadata associated with any changes, as obtained from one or more of the MDOR databases 108. For example, user interface metadata definition(s), which may be part of the file system image, may be obtained from the component 105 (as shown in FIG. 1) and may be merged with metadata definitions associated with tenant-specific, key-user, etc. adaptations to the user interface that may be stored in the database 108.

One of the advantages of obtaining metadata from different sources may include a substantial performance boost in a cloud environment (e.g., Kubernetes environment). This is because the metadata, which may already be part of the running file system image, may be used and not called and/or transferred from the database which might not be part of the same physical machine. As such, the current subject matter system may be configured to perform fewer de/serialization and/or data transfer between applications and database pods.

However, obtaining metadata entities, definitions, etc. from the file system image may require use of a non-unique primary key, e.g., “name”, and one or more secondary keys, e.g., “namespace”, “type”, as well as optional, additional, etc. set of tenant-defined secondary keys (e.g., name-value pairs). As such, one or more of the following combinations of keys may be needed to identify a specific metadata definition, entity, etc. for retrieval: name (e.g., primary non-unique key), namespace (e.g., optional secondary key), type (e.g., optional secondary key), and any other secondary keys (e.g., tenant defined, additional set of secondary keys). Database systems use entire combination of keys to determine file location identified by the combination, read metadata from the determined file in the file system, call a database for any tenant-specific adaptations to this metadata, merge/apply the tenant-specific adaptations to the content of the metadata in the file system, check if there are texts included in the content to be translated before returning the result to the tenant, apply the translation (if needed) to the content, and return the content. Conventional systems typically are unable to perform this process expediently.

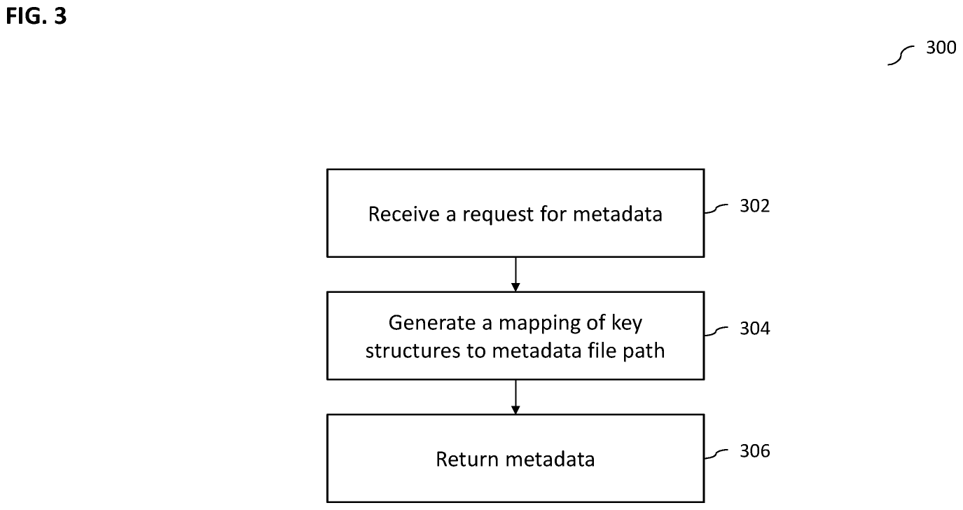

In some implementations, to quickly extract a requested metadata from the file system as well as any tenant specific metadata (e.g., using tenant specific keys) from a database, the MDOR 104 may be configured to generate one or more index files for at least one of the following scenarios: metadata read use scenario, metadata query use scenario, and translation use scenario. FIG. 3 illustrates an exemplary process 300 for extraction of requested metadata, according to some implementations of the current subject matter. At 302, the MDOR 104 (as shown in FIG. 1) may be configured to receive a request for a metadata entity (e.g., file system metadata, tenant specific metadata, definitions, etc.). At 304, the MDOR 104 may be configured to also generate a mapping between one or more metadata entity's key structures related to the name, namespace, type, and/or any secondary keys to a file path where the requested metadata is located. Once the mapping has been generated, the MDOR 104 may be configured to access the location where the requested metadata is stored, retrieve it and return the results, at 306.

In some implementations, to generate the mapping, the MDOR 104 may be configured to use a name of a metadata entity (e.g., from entity's JSON object) for which metadata is being sought and use it as a key for generating a map file (e.g., JSON map file). The following exemplary code may be used to generate such mapping:

```
{
  ″entity1″: [
    {
      ″namespace″: ″http://myns01″,
      ″type″: ″uicomponent″,
      ″secondaries″: {
        ″subType″: ″oif″
      },
      ″path″ : ″C:\\Code\\something\\entity1.OIF.uicomponent″
    }
  ]
},
{
  ″entity2″: [
    {
      ″namespace″: ″http://myns01″,
      ″type″: ″uicomponent″,
      ″secondaries″: {
        ″subType″: ″owl″
      },
      ″path″: ″C:\\Code\\something\\entity2.OWL.uicomponent″
    }
  ]
}
```

As shown by the code above, two metadata entities (i.e., “entity1” and “entity2”) have been requested. The associate keys may include “namespace” (e.g., “http://myns01”), type (a user interface component (“uicomponent”), as well as any secondary keys that may include a subtype. A path is also provided where each entity's user interface component may be stored. In this case, runtime of the MDOR 104 may be configured to directly use the requested name of the metadata entity as a key in a mapping (e.g., JSON mapping). Using the above, the MDOR 104 may be configured to generate one or more index files that may be stored by the MDOR 104 and may be used by the MDOR 104 to determine storage location of the requested metadata entity.

In some implementations, to further improve speed of access to the requested metadata, the current subject matter may be configured to generate several files/entries corresponding to each requested entity, whereby the name of the requested metadata entity may be removed from the map (e.g., file/JSON map). Here, the entity name may be used as a file name rather than being included in the file. Thus, for each entity, a separate entry in the index may be generated, as indicated by the exemplary code below:

```
File1 = entity1.json
[
  {
    ″namespace″: ″http://myns01″,
    ″type″: ″uicomponent″,
    ″secondaries″: {
      ″subType″: ″oif″
    },
    ″path″: “C:\\Code\\something\\entity1.OIF.uicomponent″
  },
]
File2 = entity2.json
[
  {
    ″namespace″: ″http://myns01″,
    ″type″: ″uicomponent″,
    ″secondaries″: {
      ″subType″: “owl″
    },
    ″path″: ″C:\\Code\\something\\entity2.OWL.uicomponent″
  }
]
```

One of the advantages of this approach would be a reduced amount of index content that may need to be stored and/or read by the MDOR 104 in determining location of the requested metadata entity. This approach may be configured to prevent storage of a large index file into memory as well as consumption of memory by the index.

In some implementations, additional information may also be added to the generated index files. For example, such additional information may include one or more data attributes associated with a particular entity and/or data related to a specific application package associated with the attributes and/or the entity. The following exemplary code illustrates addition of attribute information.

```
[
  {
    ″namespace″: ″http://myns01″,
    ″type″: ″uicomponent″,
    ″secondaries″: {
      ″subType″: ″oif″
    }
    ″attr″: {
      ″info″: ″something″
    },
    ″pkgName″: ″x4/test″,
    ″path″: ″C:\\Code\\something\\entity1.OIF.uicomponent″
  }
]
[
  {
    ″namespace″: ″http://myns01″,
    ″type″: ″uicomponent″,
    ″secondaries″: {
      ″subType″: ″owl″
    },
    ″attr″: {
      ″info″: ″something else″
    },
    ″pkgName″: ″x4/test″,
    ″path″: ″C:\\Code\\something\\entity2.0WL.uicomponent″
  }
]
```

As shown by the code above, the generate index may include an attribute “info” with a value of “something”. Additionally, application package information (e.g., “pkgName”), in addition to the path information may be incorporated into the index. As with the above exemplary code, the index entries may also be separately generated for each entity.

In some implementations, the current subject matter may be configured to generate an index for metadata entities that may require translation of text. This may mean that there may exist values in the content of a requested metadata entity, which may include a translatable text, whereby, at runtime, the tenant may wish to have this text value translated into a desired language. In some exemplary cases, translatable texts may be stored in JSON files with a file type “.text”. The files may include a semantic text with different values for different appearances, e.g., as in a column header, in a form, as a link, as a tooltip, etc. Hence, separate keys may be generated for each such text. The keys may include at least one of the following: a namespace to which the text belongs to, an identifier (ID) of the text object itself, a type of the text (e.g., appearance, system message, tooltip, column header, etc.), and language. These keys may be configured to identify a value of the text. By way of a non-limiting example, user interface metadata files may most frequently require translation of text(s) as user interfaces use a substantial amount of text(s) that may need to be translated.

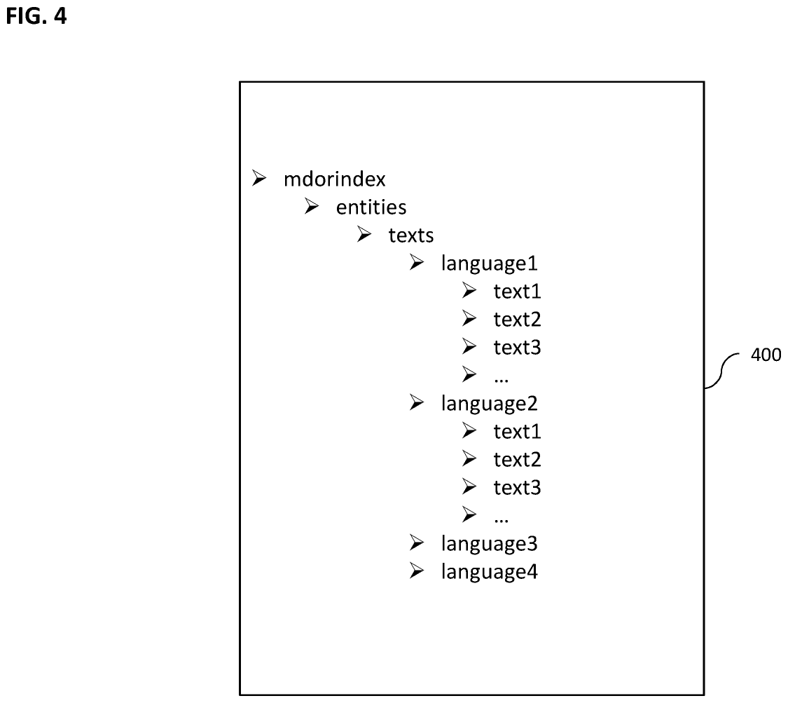

In some implementations, for indexing of texts, the current subject matter may also use namespace as a logical primary key to access texts. The namespace key may be used to name the index file so that it may be directly accessed without searching for it. Any special characters that might not be allowed for a file name but may be allowed in namespaces (e.g., “/”, “:”, etc.) may be converted into an acceptable format. FIG. 4 illustrates an exemplary local index 400, according to some implementations of the current subject matter. The local index 400 may include a root folder “mdorindex”, a sub folder “entities” for all indexed entities for the fast read case and the “texts” folder to store the texts (e.g., text1, text2, etc.) separated in different files using the namespace. Further, the texts may be separated by a specific language (e.g., English, Germany, etc.) using a language subfolder (e.g., “language1”, “language2”, etc.).

In some implementations, a unique identifier for the text may be used as a key of an object (e.g., JSON object) to identify a particular text. In some implementations, another map having the same type as the text as a key to separate different scenarios for texts that may be contained in forms, hyperlinks, columns, etc. The following exemplary code illustrates this:

```
{
  ″journalEntryUUId″: {
    ″XFLD″: ″JournalEntry UUID″
  },
  ″journalEntryId″: {
    ″XLNK″: ″JournalEntry ID″
  },
  ″companyUUId″: {
    ″XCOL″: ″Company UUID″
  }
}
```

In some implementations, the texts may be translated into most commonly used languages rather than into all languages. One or more placeholder folders may be included for language(s) that are not commonly used, as shown in FIG. 4 by “language3” and “language4” placeholders. As such, when a translation into placeholder language of a specific text becomes available and/or is requested, the folders may be populated with appropriate information.

In some implementations, the current subject matter may be configured to generate indexes for query access scenario. To generate a fast query access for the local indexed files, an index file including a map (e.g., JSON map) including searchable keys for a namespace, a type, secondary keys and/or attributes may be generated. The keys may be used to generate a map. The map may include a value as the key of the map and one or more arrays of possible targets as an array of file names of the local file index. The file names of the array may be file names of the local index generated for the read scenario, as discussed above. The following exemplary code illustrates the query scenario:

```
{
  ″namespace″: {
    ″http://myns01″: [
      ″<file name>″
    ]
},
  ″type″: {
    ″UICOMPONENT″: [
      ″<file name>″
    ]
},
  ″secondaries″:{
    ″subType″: {
      ″oif″: [
        ″<file name>″
      ]
    }
  },
  ″attributes″: {
    ″info″: {
      ″something else″: [
        ″<file name>″
      ]
    }
  }
}
```

In some implementations, the current subject matter can be implemented in various in-memory database systems, such as a High-Performance Analytic Appliance (“HANA”) system as developed by SAP SE, Walldorf, Germany. Various systems, such as, enterprise resource planning (“ERP”) system, supply chain management (“SCM”) system, supplier relationship management (“SRM”) system, customer relationship management (“CRM”) system, and/or others, can interact with the in-memory system for the purposes of accessing data, for example. Other systems and/or combinations of systems can be used for implementations of the current subject matter. The following is a discussion of an exemplary in-memory system.

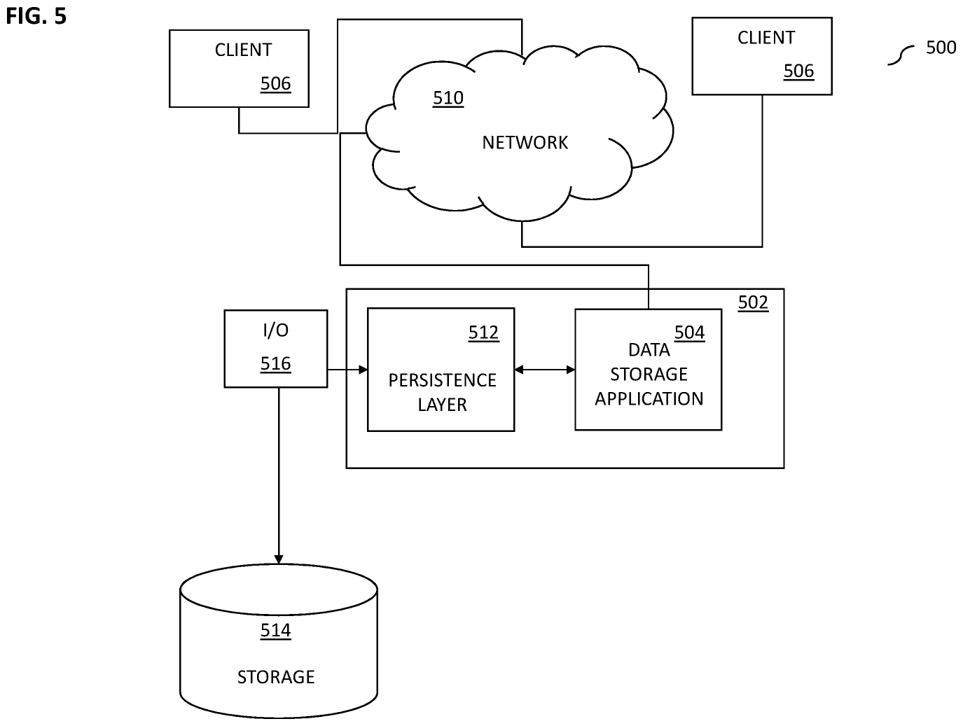

FIG. 5 illustrates an exemplary system 500 in which a computing system 502, which can include one or more programmable processors that can be collocated, linked over one or more networks, etc., executes one or more modules, software components, or the like of a data storage application 504, according to some implementations of the current subject matter. The data storage application 504 can include one or more of a database, an enterprise resource program, a distributed storage system (e.g. NetApp Filer available from NetApp of Sunnyvale, Calif.), or the like.

The one or more modules, software components, or the like can be accessible to local users of the computing system 502 as well as to remote users accessing the computing system 502 from one or more client machines 506 over a network connection 510. One or more user interface screens produced by the one or more first modules can be displayed to a user, either via a local display or via a display associated with one of the client machines 506. Data units of the data storage application 504 can be transiently stored in a persistence layer 512 (e.g., a page buffer or other type of temporary persistency layer), which can write the data, in the form of storage pages, to one or more storages 514, for example via an input/output component 516. The one or more storages 514 can include one or more physical storage media or devices (e.g. hard disk drives, persistent flash memory, random access memory, optical media, magnetic media, and the like) configured for writing data for longer term storage. It should be noted that the storage 514 and the input/output component 516 can be included in the computing system 502 despite their being shown as external to the computing system 502 in FIG. 5.

Data retained at the longer term storage 514 can be organized in pages, each of which has allocated to it a defined amount of storage space. In some implementations, the amount of storage space allocated to each page can be constant and fixed. However, other implementations in which the amount of storage space allocated to each page can vary are also within the scope of the current subject matter.

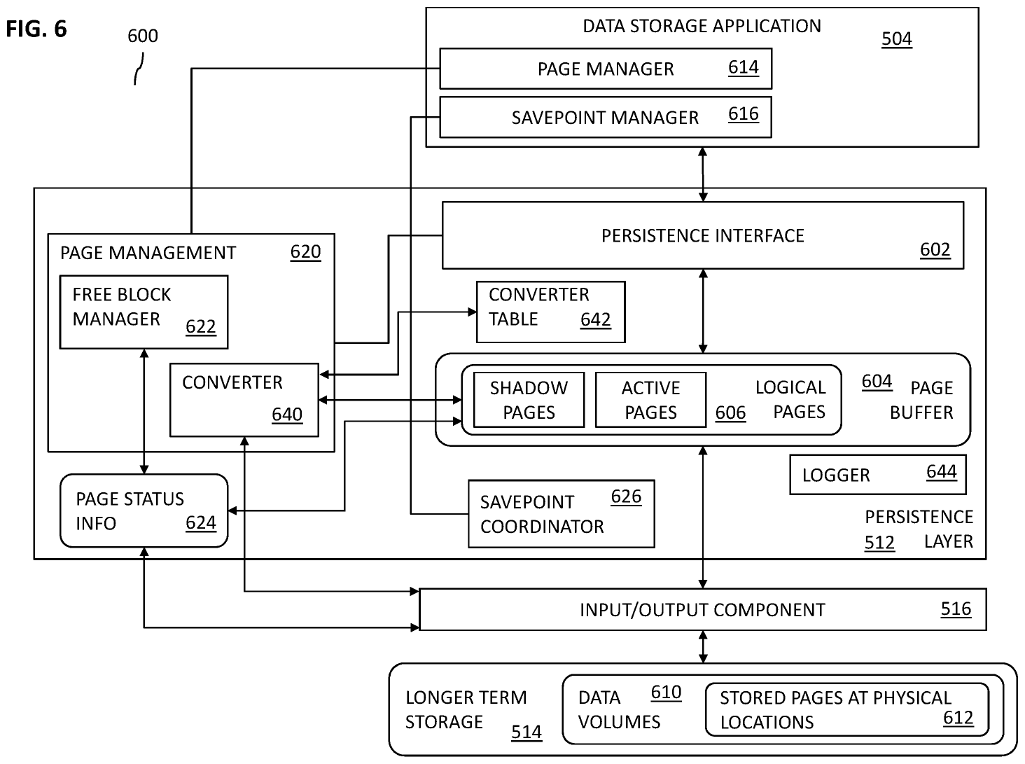

FIG. 6 illustrates exemplary software architecture 600, according to some implementations of the current subject matter. A data storage application 504, which can be implemented in one or more of hardware and software, can include one or more of a database application, a network-attached storage system, or the like. According to at least some implementations of the current subject matter, such a data storage application 504 can include or otherwise interface with a persistence layer 512 or other type of memory buffer, for example via a persistence interface 602. A page buffer 604 within the persistence layer 512 can store one or more logical pages 606, and optionally can include shadow pages, active pages, and the like. The logical pages 606 retained in the persistence layer 512 can be written to a storage (e.g. a longer term storage, etc.) 514 via an input/output component 516, which can be a software module, a sub-system implemented in one or more of software and hardware, or the like. The storage 514 can include one or more data volumes 610 where stored pages 612 are allocated at physical memory blocks.

In some implementations, the data storage application 504 can include or be otherwise in communication with a page manager 614 and/or a savepoint manager 616. The page manager 614 can communicate with a page management module 620 at the persistence layer 512 that can include a free block manager 622 that monitors page status information 624, for example the status of physical pages within the storage 514 and logical pages in the persistence layer 512 (and optionally in the page buffer 604). The savepoint manager 616 can communicate with a savepoint coordinator 626 at the persistence layer 512 to handle savepoints, which are used to create a consistent persistent state of the database for restart after a possible crash.

In some implementations of a data storage application 504, the page management module of the persistence layer 512 can implement a shadow paging. The free block manager 622 within the page management module 620 can maintain the status of physical pages. The page buffer 604 can include a fixed page status buffer that operates as discussed herein. A converter component 640, which can be part of or in communication with the page management module 620, can be responsible for mapping between logical and physical pages written to the storage 514. The converter 640 can maintain the current mapping of logical pages to the corresponding physical pages in a converter table 642. The converter 640 can maintain a current mapping of logical pages 606 to the corresponding physical pages in one or more converter tables 642. When a logical page 606 is read from storage 514, the storage page to be loaded can be looked up from the one or more converter tables 642 using the converter 640. When a logical page is written to storage 514 the first time after a savepoint, a new free physical page is assigned to the logical page. The free block manager 622 marks the new physical page as “used” and the new mapping is stored in the one or more converter tables 642.

The persistence layer 512 can ensure that changes made in the data storage application 504 are durable and that the data storage application 504 can be restored to a most recent committed state after a restart. Writing data to the storage 514 need not be synchronized with the end of the writing transaction. As such, uncommitted changes can be written to disk and committed changes may not yet be written to disk when a writing transaction is finished. After a system crash, changes made by transactions that were not finished can be rolled back. Changes occurring by already committed transactions should not be lost in this process. A logger component 644 can also be included to store the changes made to the data of the data storage application in a linear log. The logger component 644 can be used during recovery to replay operations since a last savepoint to ensure that all operations are applied to the data and that transactions with a logged “commit” record are committed before rolling back still-open transactions at the end of a recovery process.

With some data storage applications, writing data to a disk is not necessarily synchronized with the end of the writing transaction. Situations can occur in which uncommitted changes are written to disk and while, at the same time, committed changes are not yet written to disk when the writing transaction is finished. After a system crash, changes made by transactions that were not finished must be rolled back and changes by committed transaction must not be lost.

To ensure that committed changes are not lost, redo log information can be written by the logger component 644 whenever a change is made. This information can be written to disk at latest when the transaction ends. The log entries can be persisted in separate log volumes while normal data is written to data volumes. With a redo log, committed changes can be restored even if the corresponding data pages were not written to disk. For undoing uncommitted changes, the persistence layer 512 can use a combination of undo log entries (from one or more logs) and shadow paging.

The persistence interface 602 can handle read and write requests of stores (e.g., in-memory stores, etc.). The persistence interface 602 can also provide write methods for writing data both with logging and without logging. If the logged write operations are used, the persistence interface 602 invokes the logger 644. In addition, the logger 644 provides an interface that allows stores (e.g., in-memory stores, etc.) to directly add log entries into a log queue. The logger interface also provides methods to request that log entries in the in-memory log queue are flushed to disk.

Log entries contain a log sequence number, the type of the log entry and the identifier of the transaction. Depending on the operation type additional information is logged by the logger 644. For an entry of type “update”, for example, this would be the identification of the affected record and the after image of the modified data.

When the data application 504 is restarted, the log entries need to be processed. To speed up this process the redo log is not always processed from the beginning. Instead, as stated above, savepoints can be periodically performed that write all changes to disk that were made (e.g., in memory, etc.) since the last savepoint. When starting up the system, only the logs created after the last savepoint need to be processed. After the next backup operation the old log entries before the savepoint position can be removed.

When the logger 644 is invoked for writing log entries, it does not immediately write to disk. Instead it can put the log entries into a log queue in memory. The entries in the log queue can be written to disk at the latest when the corresponding transaction is finished (committed or aborted). To guarantee that the committed changes are not lost, the commit operation is not successfully finished before the corresponding log entries are flushed to disk. Writing log queue entries to disk can also be triggered by other events, for example when log queue pages are full or when a savepoint is performed.

With the current subject matter, the logger 644 can write a database log (or simply referred to herein as a “log”) sequentially into a memory buffer in natural order (e.g., sequential order, etc.). If several physical hard disks/storage devices are used to store log data, several log partitions can be defined. Thereafter, the logger 644 (which as stated above acts to generate and organize log data) can load-balance writing to log buffers over all available log partitions. In some cases, the load-balancing is according to a round-robin distributions scheme in which various writing operations are directed to log buffers in a sequential and continuous manner. With this arrangement, log buffers written to a single log segment of a particular partition of a multi-partition log are not consecutive. However, the log buffers can be reordered from log segments of all partitions during recovery to the proper order.

As stated above, the data storage application 504 can use shadow paging so that the savepoint manager 616 can write a transactionally-consistent savepoint. With such an arrangement, a data backup comprises a copy of all data pages contained in a particular savepoint, which was done as the first step of the data backup process. The current subject matter can be also applied to other types of data page storage.

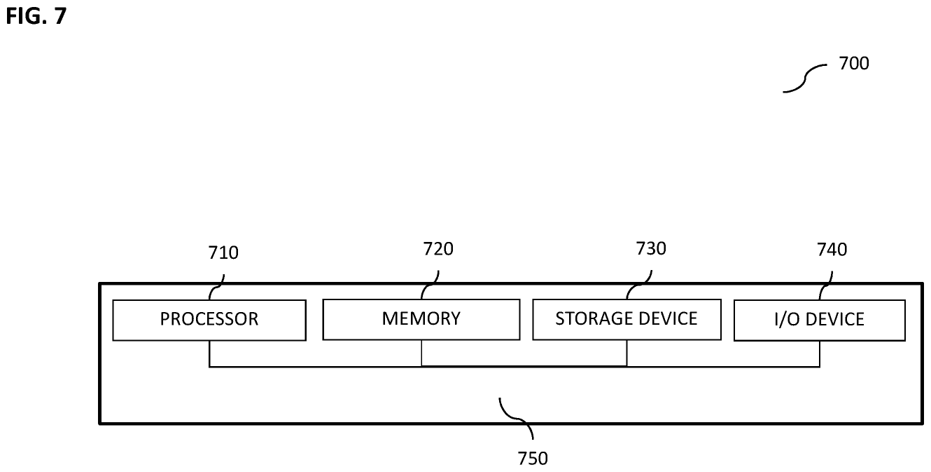

In some implementations, the current subject matter can be configured to be implemented in a system 700, as shown in FIG. 7. The system 700 can include a processor 710, a memory 720, a storage device 730, and an input/output device 740. Each of the components 710, 720, 730 and 740 can be interconnected using a system bus 750. The processor 710 can be configured to process instructions for execution within the system 700. In some implementations, the processor 710 can be a single-threaded processor. In alternate implementations, the processor 710 can be a multi-threaded processor. The processor 710 can be further configured to process instructions stored in the memory 720 or on the storage device 730, including receiving or sending information through the input/output device 740. The memory 720 can store information within the system 700. In some implementations, the memory 720 can be a computer-readable medium. In alternate implementations, the memory 720 can be a volatile memory unit. In yet some implementations, the memory 720 can be a non-volatile memory unit. The storage device 730 can be capable of providing mass storage for the system 700. In some implementations, the storage device 730 can be a computer-readable medium. In alternate implementations, the storage device 730 can be a floppy disk device, a hard disk device, an optical disk device, a tape device, non-volatile solid state memory, or any other type of storage device. The input/output device 740 can be configured to provide input/output operations for the system 700. In some implementations, the input/output device 740 can include a keyboard and/or pointing device. In alternate implementations, the input/output device 740 can include a display unit for displaying graphical user interfaces.

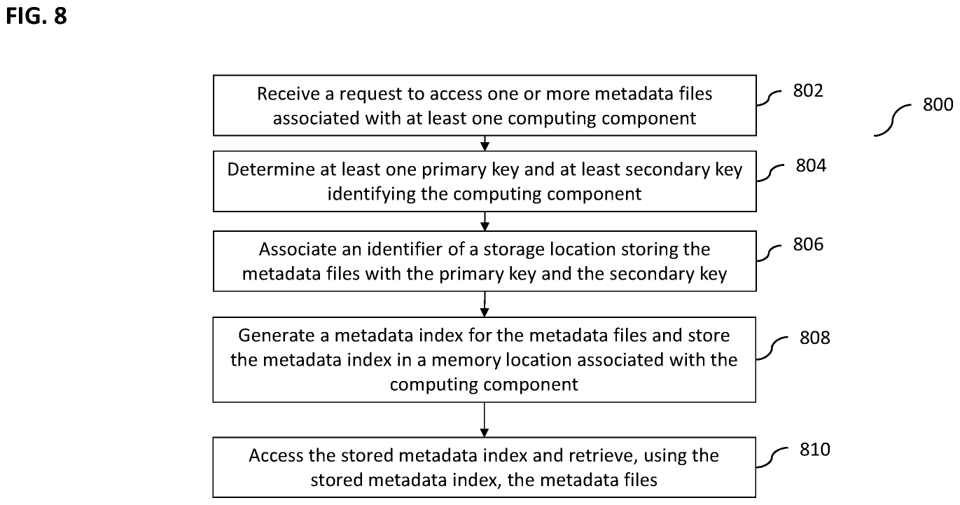

FIG. 8 illustrates an exemplary method 800 for retrieving metadata files using a local metadata index, according to some implementations of the current subject matter. The method 800 may be executed by the system 100 (shown in FIG. 1), and in particular the MDOR 104, as shown in FIG. 1. The method 800 may implement the techniques discussed above in connection with FIGS. 2-4.

At 802, a request to access one or more metadata files associated with at least one computing component may be received. The request may be received by the MDOR 104 shown in FIG. 1. The metadata files may be associated with a file system, a particular software application, tenant modifications, etc. Some of the metadata files, particularly those associated with a file system and/or applications that may be part of the file system, may be stored in a local file system image (e.g., image 202 as shown in FIG. 2). Any tenant modifications, changes, add-ons, preferences, etc. may be stored in an MDOR database (e.g., database 108).

At 804, the MDOR 104 may determine at least one primary key (e.g., namespace) and at least secondary key (e.g., type, subtype, secondaries, etc. as shown by the exemplary codes above) that may identify the computing component. The keys may be different depending on a type of access, e.g., read access, translation, query, etc.

At 806, the MDOR 104 may associate an identifier of a storage location storing the metadata files with the primary key and the secondary key. Here, the identifier may include a file path indicating where the requested metadata files may be stored (e.g., local file system image 202, MDOR database 108, and/or both, and/or any other location).

At 808, the MDOR may generate a metadata index for the metadata files. The metadata index may include the primary key, the secondary key, and the associated identifier of the storage location. This is illustrated by the various exemplary code discussed above. The metadata index may be stored in a memory location associated with the computing component. At 810, the MDOR may access the stored metadata index and retrieve the metadata files.

In some implementations, the current subject matter may include one or more of the following optional features. For example, the computing component may include at least one of the following: a file system, a software application, one or more modifications to the file system, one more modification to the software application, and any combination thereof. The metadata files may be stored in at least one of the following: a local file system image, a database of a metadata object repository, and any combination thereof.

In some implementations, the identifier of the storage location may include a file path associated with the metadata files. The primary key may include a name associated with the computing component. The secondary key may include a type of the computing component. Alternatively, or in addition to, the secondary key may include one or more attributes associated with the computing component. Further, the secondary key may include an identification of a language associated with the metadata files. The metadata files may include one or more metadata files translated into at least one or more languages.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
receiving a request to access one or more metadata files associated with at least one computing component;
determining at least one primary key and at least secondary key identifying the computing component;
associating an identifier of a storage location storing the one or more metadata files with the at least one primary key and the at least one secondary key;
generating a metadata index for the one or more metadata files, the metadata index including the at least one primary key, the at least one secondary key, and the associated identifier of the storage location, and storing the metadata index in a memory location associated with the at least one computing component; and
accessing the stored metadata index and retrieving, using the stored metadata index, the one or more metadata files.

2. The method according to claim 1, wherein the computing component including at least one of the following: a file system, a software application, one or more modifications to the file system, one more modification to the software application, and any combination thereof.

3. The method according to claim 2, wherein the metadata files are stored in at least one of the following: a local file system image, a database of a metadata object repository, and any combination thereof.

4. The method according to claim 1, wherein the identifier of the storage location includes a file path associated with the one or more metadata files.

5. The method according to claim 1, wherein the at least one primary key includes a name associated with the at least one computing component.

6. The method according to claim 5, wherein the at least one secondary key includes a type of the at least one computing component.

7. The method according to claim 5, wherein the at least one secondary key includes one or more attributes associated with the at least one computing component.

8. The method according to claim 5, wherein the at least one secondary key includes an identification of a language associated with the one or more metadata files.

9. The method according to claim 8, wherein the one or more metadata files include one or more metadata files translated into at least one or more languages.

10. A system comprising:
at least one programmable processor; and
a non-transitory machine-readable medium storing instructions that, when executed by the at least one programmable processor, cause the at least one programmable processor to perform operations comprising:
receiving a request to access one or more metadata files associated with at least one computing component;
determining at least one primary key and at least secondary key identifying the computing component;
associating an identifier of a storage location storing the one or more metadata files with the at least one primary key and the at least one secondary key;
generating a metadata index for the one or more metadata files, the metadata index including the at least one primary key, the at least one secondary key, and the associated identifier of the storage location, and storing the metadata index in a memory location associated with the at least one computing component; and
accessing the stored metadata index and retrieving, using the stored metadata index, the one or more metadata files.

11. The system according to claim 10, wherein the computing component including at least one of the following: a file system, a software application, one or more modifications to the file system, one more modification to the software application, and any combination thereof.

12. The system according to claim 11, wherein the metadata files are stored in at least one of the following: a local file system image, a database of a metadata object repository, and any combination thereof.

13. The system according to claim 10, wherein the identifier of the storage location includes a file path associated with the one or more metadata files.

14. The system according to claim 10, wherein the at least one primary key includes a name associated with the at least one computing component.

15. The system according to claim 14, wherein the at least one secondary key includes a type of the at least one computing component.

16. The system according to claim 14, wherein the at least one secondary key includes one or more attributes associated with the at least one computing component.

17. The system according to claim 14, wherein the at least one secondary key includes an identification of a language associated with the one or more metadata files.

18. The system according to claim 17, wherein the one or more metadata files include one or more metadata files translated into at least one or more languages.

19. A computer program product comprising a non-transitory machine-readable medium storing instructions that, when executed by at least one programmable processor, cause the at least one programmable processor to perform operations comprising:
receiving a request to access one or more metadata files associated with at least one computing component;
determining at least one primary key and at least secondary key identifying the computing component;
associating an identifier of a storage location storing the one or more metadata files with the at least one primary key and the at least one secondary key;
generating a metadata index for the one or more metadata files, the metadata index including the at least one primary key, the at least one secondary key, and the associated identifier of the storage location, and storing the metadata index in a memory location associated with the at least one computing component; and
accessing the stored metadata index and retrieving, using the stored metadata index, the one or more metadata files.

20. The computer program product according to claim 19, wherein the computing component including at least one of the following: a file system, a software application, one or more modifications to the file system, one more modification to the software application, and any combination thereof;
the metadata files are stored in at least one of the following: a local file system image, a database of a metadata object repository, and any combination thereof.
